(19) United States
(12) Patent Application Publication
(10) Pub. No.: US 2008/0229320 A1
(43) Pub. Date: Sep. 18, 2008

(54) Method, an apparatus and a system for controlling of parallel execution of services

(75) Inventor: Haruyasu Ueda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 12/076,013

(22) Filed: Mar. 12, 2008

(30) Foreign Application Priority Data
Mar. 15, 2007 (JP) 2007-067442

(51) Int. Cl. G06F 9/50

(52) U.S. Cl. 718/104

(57) ABSTRACT

According to an aspect of an embodiment, a method for controlling a plurality of nodes for executing a plurality of services, each of the services comprising a plurality of job nets which are to be executed sequentially, the method comprising: allocating at least one node for each of said services and initiating execution of said services by said nodes; obtaining weight information of job nets instantaneously executed for each of the services; and dynamically changing the allocation of the nodes for the services in accordance with the weight information.

### TECHNICAL FIELD

The present disclosure relates to a parallel execution program, a recording medium storing the program, a parallel execution device and a parallel execution method, which execute batch jobs parallel using a plurality of resource nodes.

### SUMMARY

According to an aspect of an embodiment, a method for controlling a plurality of nodes for executing a plurality of services, each of the services comprising a plurality of job nets which are to be executed sequentially, the method comprising: allocating at least one node for each of said services and initiating execution of said services by said nodes; obtaining weight information of job nets instantaneously executed for each of the services; and dynamically changing the allocation of the nodes for the services in accordance with the weight information.

### BRIEF DESCRIPTION OF THE DRAWINGS

FIG. 1 is a system configuration diagram of a resource brokering system according to an embodiment;

FIG. 2 is a diagram that illustrates the contents stored in an allocation requests list table;

FIG. 3 is a diagram that illustrates the contents stored in a resources list table;

FIG. 4 is a diagram that illustrates the contents stored in an allocated resources list table;

FIG. 5 is a diagram that illustrates a hardware configuration of a computer device shown in FIG. 1;

FIG. 6 is a block diagram that shows a functional configuration of a parallel execution device according to the embodiment;

FIG. 7 is a flowchart that shows a parallel execution procedure of the parallel execution device according to the embodiment;

FIG. 8 is a flowchart that shows a resource return procedure;

FIG. 9 is a detailed system configuration diagram of the resource brokering system;

FIG. 10 is a sequence diagram that shows a resource brokering process according to a first exemplary embodiment;

FIG. 11 is a diagram that illustrates a specific system configuration of the resource brokering system according to the first exemplary embodiment;

FIG. 12 is a sequence diagram (part I) that shows a parallel execution process according to the first exemplary embodiment;

FIG. 13 is a sequence diagram (part II) that shows a parallel execution process according to the first exemplary embodiment;

FIG. 14 is a sequence diagram (part III) that shows a parallel execution process according to the first exemplary embodiment;

FIG. 15 is a diagram (part I) that illustrates an example of execution of the resource brokering system;

FIG. 16 is a diagram (part II) that illustrates an example of execution of the resource brokering system;

FIG. 17 is a diagram (part III) that illustrates an example of execution of the resource brokering system;

FIG. 18 is a diagram that illustrates a specific system configuration of a resource brokering system according to a second exemplary embodiment; and

FIG. 19 is a diagram that illustrates a specific system configuration of a resource brokering system according to a third exemplary embodiment.

### DESCRIPTION OF THE PREFERRED EMBODIMENTS

First, a technology, to which an embodiment has not yet applied, will now be described. In an existing art, because of inflexible system configuration, large additional sum of investment might be required to improve throughput. For example, as business situation changes, required peak performance is increased. Hence, it is necessary to have an additional computational resource. In contrast, by expecting a sudden increase in load, a large amount of auxiliary computational resources may be ensured in advance. However, most cases result in wasteful spending.

Then, a technology for improving the use efficiency of computational resources by sharing computational resources among services using, in busy time, the computational resources saved for other services has been provided. In recent years, in a technical field in which such a computational resource is optimally used, there is an increasing need for technology in which computational resources are allocated to each service on the basis of the importance levels of the services.

For example, a technology has been provided, in which, when application servers for executing a plurality of applications are needed, a load on each allocatable application server is measured, and then the number of application servers activated is adjusted among the applications.

In addition, another technology has been provided, in which, in regard to batch jobs, a policy is set to each account or each group, and the number of jobs simultaneously executed is adjusted on the basis of the policy.

Yet another technology has been provided, in which, by setting a plurality of parallel operable batch jobs instead of newly developing parallel execution application, and waiting completion of these batch jobs, the resource brokering is appropriately performed between application servers and batch jobs, which is, for example, described in Japanese Unexamined Patent Application Publication No. 2004-334493.

However, according to the technologies, to which the embodiment has not yet applied, individual services determine the values of exclusive computational resources on respective bases of values and then use them. For this reason, there has been a problem in which basis of value is different between an interactive service, such as an online application, and a non-interactive service, such as a batch application, and, hence, it is difficult to interchange computational resources therebetween.

Moreover, according to the technology, described in JP-A-2004-334493, to which the embodiment has not yet applied, when an application is executed parallel with a priority level equivalent to a priority level given to an online application, there has been a problem in which it is extremely difficult to interchange computational resources between those services.

The reason is that a policy for resource brokering is separated into a policy related to a resource broker that manages the allocation status of computational resources that are used between the services and a policy for allocating jobs inside a batch system, so that it is difficult to manage interchanging of computational resources throughout.

For example, when a job having a high priority level and a job having a low priority level are present in a batch system, an extremely complex algorithm is required to request appropriate numbers of computational resources, so that there has been a problem in which manpower and working hours, used for creating the algorithm, increase.

Particularly, when a resource request is issued from the batch system so as to be a batch job group having a priority level equivalent to a certain specific service, it is necessary to issue a resource request with the same priority level as the priority level given to the certain service. Thus, the priority level given to a specific service is determined in advance, and the priority level given to the batch system is then set to that priority level, and thereafter a resource request is issued. Hence, a further complex algorithm is required.

Yet furthermore, when a job that has a new priority level is set in the batch system, there has been a problem in which it is necessary to revise the priority level set to the batch system and, hence, costs for the revision arise.

In order to eliminate the above problems in the technologies to which the embodiment has not yet applied, it is an object of the embodiment to provide a parallel execution program, a recording medium that stores the above program, a parallel execution device and a parallel execution method that, which are able to smoothly provide individual services by executing resource brokering effectively for each job net.

In order to eliminate the above problems and to achieve the object, an embodiment provides a parallel execution program, a recording medium that stores the program, a parallel execution device and a parallel execution method, which execute a job using a resource node that is allocated by a resource broker that manages the allocation status of the resource node used for a service, receive input of script data related to a job net in which job execution sequence is defined, issue an allocation request of resource nodes that are used to execute the job net on the basis of the script data in units of job net, and allocate, to each job net, a resource node that is allocated by the resource broker in response to the allocation request.

In addition, in the above described embodiment, an allocation request of the resource node that is used to execute the corresponding job net may be transmitted to the resource broker, as a result that the allocation request has been transmitted, an allocation response of the resource node that may be used to execute the corresponding job net may be received from the resource broker, and the resource node may be allocated to the corresponding job net on the basis of the allocation response.

According to the above described embodiments, when a plurality of job nets are executed parallel, an allocation request is issued for each job net and, as a result, resource nodes allocated from the resource broker may be allocated to the corresponding job nets.

Moreover, in the above described embodiments, after resource nodes have been allocated to the job net, it may be detected whether resource nodes used for the job net are insufficient, and, when it is detected that the resource nodes are insufficient, an allocation request of resource nodes used for that job net may be transmitted to the resource broker.

According to the above embodiment, when resources become insufficient during execution of the job net that use resource nodes allocated to each job net, it is possible to issue an allocation request of resource nodes that are additionally allocated to the job net.

Furthermore, in the above embodiment, after resource nodes have been allocated to each job net, it may be detected whether execution of the job net is completed and, when completion of execution is detected, a return notification of the resource nodes that are allocated to the job net may be transmitted to the resource broker.

According to the above embodiment, when execution of a job net is completed, it is possible to return resource nodes allocated to the job net to the resource broker.

Furthermore, in the above embodiment, after the resources nodes have been allocated to the job net, when a release request of the resource nodes is received from the resource broker, utilization of the resource nodes specified by the release request may be stopped.

According to the above embodiment, when a release request of the resource nodes is issued, it is possible to interrupt or abort execution of the job net that uses those resource nodes.

Moreover, in the above embodiment, when utilization of the resource nodes is stopped, a return notification of those resource nodes may be transmitted to the resource broker.

According to the above embodiment, it is possible to return the resource nodes, for which a release request is issued from the resource broker, to the resource broker.

According to the parallel execution program, the recording medium that stores the program, the parallel execution device and the parallel execution method, according to the embodiment, it is advantageous in that individual services may be smoothly offered by effectively executing resource brokering for each job net.

The parallel execution program, the recording medium that stores the program, the parallel execution device and the parallel execution method, according to the embodiment, will now be described in detail with reference to the accompanying drawings.

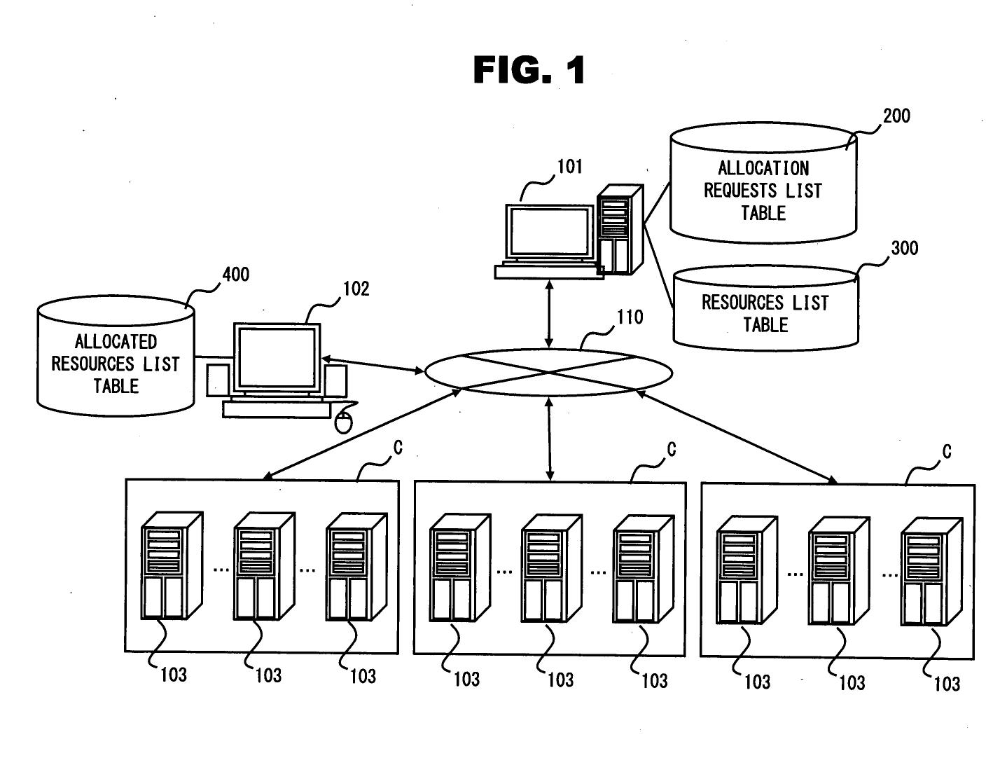

System Configuration Diagram of Resource Brokering System First, the system configuration of the resource brokering system according to the embodiment will be described. FIG. 1 is a system configuration diagram of a resource brokering system according to the embodiment. As shown in FIG. 1, the resource brokering system 100 includes a resource brokering device 101, a parallel execution device 102, and resource nodes 103 that are installed at sites C. These resource brokering device 101, parallel execution device 102 and resource nodes 103 are connected through a network 110 so as to be communicable one another.

The resource brokering device 101 is a computer device that brokers the resource nodes 103 used among a plurality of services, and includes an allocation requests list table 200 and a resources list table 300. Specifically, the resource brokering device 101 determines which resource node 103 in which site C is allocated in response to a requested service or allocates the resource node 103, which is installed in a certain site C that offers a certain service, to other services.

The parallel execution device 102 is a computer device that receives a request for a service (batch process, or the like). The parallel execution device 102 issues a resource request for each job net (batch job) to the resource brokering device 101 in response to the service received. Furthermore, the parallel execution device 102 has the function to execute each job net using the allocated resource nodes 103.

In addition, the resource nodes 103 are installed at each site C, and are computer devices that offer services, which are allocated by the resource brokering device 101, to the parallel execution device 102 or other client terminals (not shown).

### Contents Stored in Allocation Requests List Table

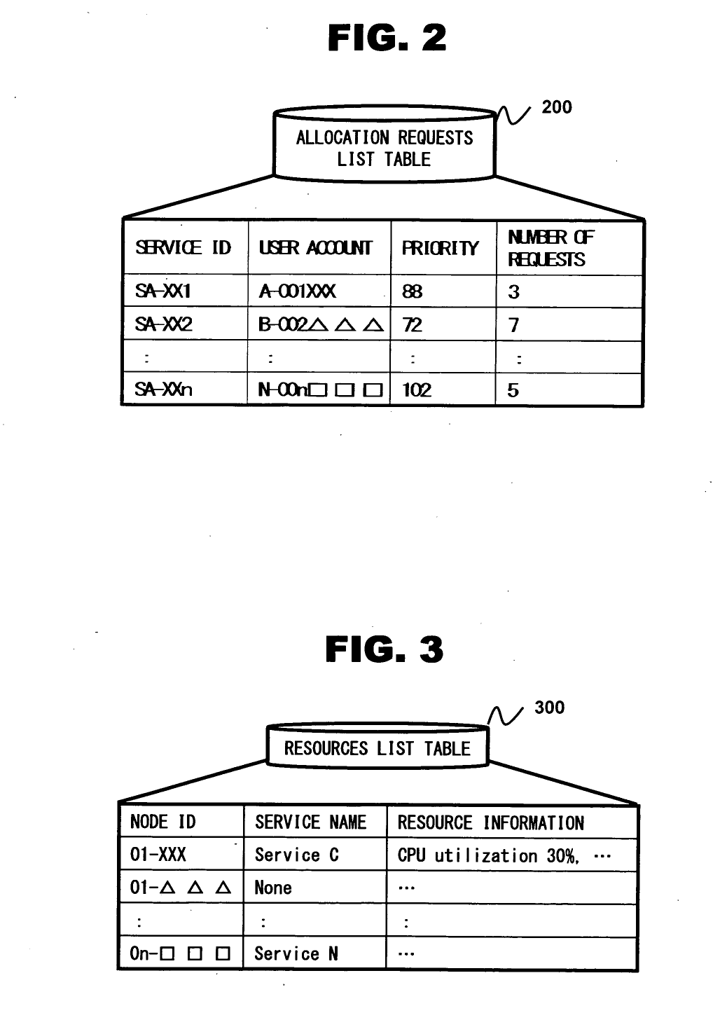

Next, the allocation requests list table 200 will be described. FIG. 2 is a diagram that illustrates the contents stored in the allocation requests list table 200. As shown in FIG. 2, the allocation requests list table 200 stores therein information regarding service ID, user account, priority and the number of requests for each allocation request of the resource nodes 103, which is issued to the resource brokering device 101.

The service ID is identification information, with which a service to be allocated is identified. The user account is identification information, with which a user that issues an allocation request is identified, and is set to each user. The priority is information that represents the priority level of the resource node 103 requested. Here, higher numeric value of the priority indicates that the priority level is higher.

The number of requests represents the number of resource nodes 103 requested. The contents stored in the allocation requests list table 200 will be updated every time an allocation request is received from a user. The resource brokering device 101 executes brokering of the resource nodes 103 on the basis of the priority in accordance with the policy of the resource brokering system 100.

### Contents Stored in Resources List Table

Next, the resources list table 300 will be described. FIG. 3 is a diagram that illustrates the contents stored in the resources list table 300. As shown in FIG. 3, the resources list table 300 stores therein node ID, service name, and resource information for each resource node 103 under the control of the resource brokering device 101.

The node ID is identification information, with which resource nodes 103 installed at the sites C are identified, and is set to each resource node 103. The service name is the name of service allocated thereto. Note that “none” is present at the items corresponding to the resource nodes 103 that are not allocated to any services. In addition, service ID, with which a service is identified, is associated with the corresponding service name.

The resource information is information related to each resource node 103. For example, the resource information may be static information, such as IP address of the resource node 103, usable OS, CPU performance, or application software installed, or may be dynamic information, such as CPU utilization, or memory utilization.

### Contents Stored in Allocated Resources List Table

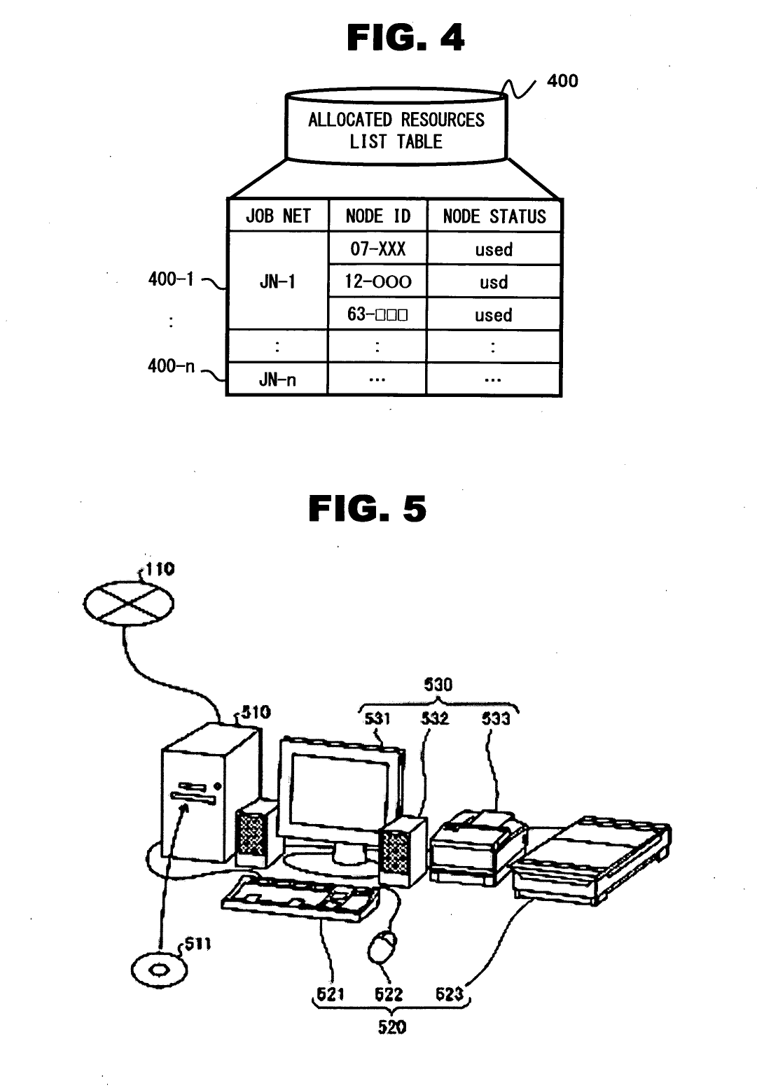

Next, the allocated resources list table 400 will be described. FIG. 4 is a diagram that illustrates the contents stored in the allocated resources list table 400. As shown in FIG. 4, the allocated resources list table 400 stores therein resource information 400-1 to 400-n related to job net number, node ID, and node status for each job net.

The job net number is identification number, with which each job net is identified. The node ID is identification information, with which resource nodes 103 allocated to each job net are identified. The node status is information that represents the allocation status of each resource node 103. When the resource node 103 is being used for execution of the job net, the node status will be “in use”. When the resource node 103 is not being used for execution of the job net, the node status will be “not in use”.

Here, a description will be made using an example of job net having a job net number of “JN-1”. Three resource nodes 103 having node IDs of “07-XXX”, “12-OOO” and “63-□□□” are allocated to this job net (JN-1). Three resource nodes 103 are all used for execution of the job net (JN-1).

### Hardware Configuration of Computer Device

Next, the hardware configuration of the computer device shown in FIG. 1 will be described. FIG. 5 is a diagram that illustrates the hardware configuration of the computer device shown in FIG. 1. As shown in FIG. 5, the computer device includes a computer body 510, an input device 520, and an output device 530. These computer body 510, input device 520 and output device 530 may be connected to the network 110, such as LAN, WAN, or Internet, through a router or a modem (not shown).

The computer body 510 includes a CPU, a memory, and an interface. The CPU governs control of the entire hardware configuration of the computer device. The memory includes a ROM, a RAM, an HD, an optical disk 511, and a flash memory. The memory is used as a work area for the CPU.

In addition, various programs are stored in the memory and will be loaded in response to instructions from the CPU. In the HD and the optical disk 511, reading/writing of data is controlled by a disk drive. Furthermore, the optical disk 511 and the flash memory are detachable relative to the computer body 510. The interface controls input from the input device 520, output to the output device 530, and transmission and reception to and from the network 110.

Moreover, the input device 520 includes a keyboard 521, a mouse 522, a scanner 523, and the like. The keyboard 521 is provided with keys for input of characters, numerals, various instructions, or the like, and inputs data. The input device 520 may be a touch panel. The mouse 522 is used for moving cursor, range selection, moving or resizing window. The scanner 523 optically reads an image. The read image is taken in as image data, and stored in the memory of the computer body 510. Note that the scanner 523 may be provided with an OCR function.

In addition, the output device 530 may be a display 531, a speaker 532, a printer 533, or the like. The display 531 displays not only a cursor, an icon, and a tool box but also data, such as a document, an image, and function information. Moreover, the speaker 532 outputs sound, such as sound effect or reading sound. Furthermore, the printer 533 prints out image data or document data.

### Functional Configuration of Parallel Execution Device 102

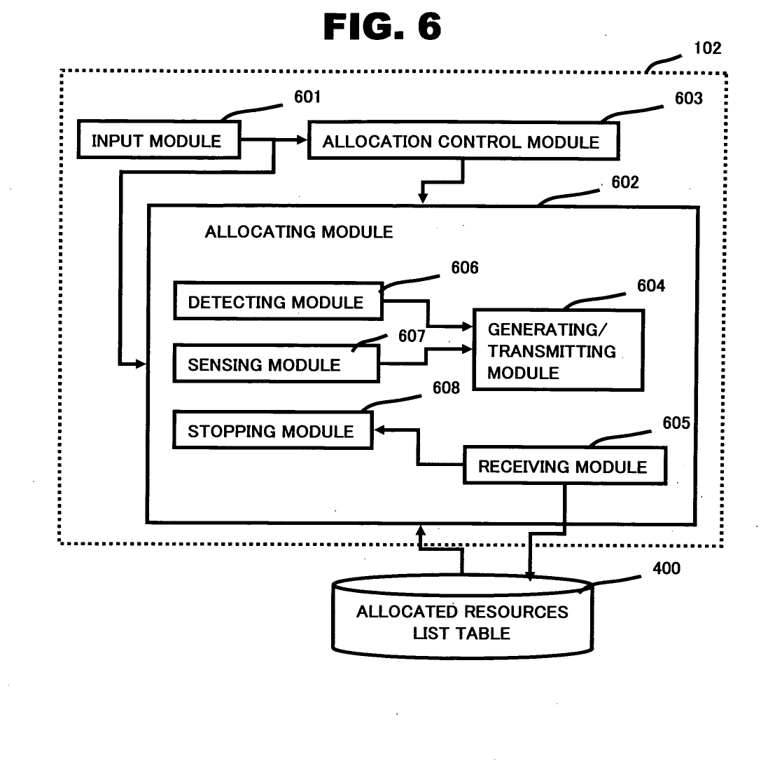

Next, the functional configuration of the parallel execution device 102 according to the embodiment will be described. FIG. 6 is a block diagram that shows the functional configuration of the parallel execution device 102 according to the embodiment. As shown in FIG. 6, the parallel execution device 102 includes an allocated resources list table 400, an input module 601, an allocating module 602, an allocation control module 603, a generating/transmitting module 604, a receiving module 605, a detecting module 606, a sensing module 607, and a stopping module 608. Note that, in the present embodiment, image data, or the like, are stored in the memory; however, it may be configured in a recording medium, such as a hard disk, instead of the memory.

These functional modules 601 to 608 may be implemented by executing programs, corresponding to the functions, stored in the memory, on the CPU. In addition, data output from the functional modules 601 to 608 are held in the memory. Furthermore, the functional configuration of the connection destination shown by arrows in FIG. 6 allows the program corresponding to the function modules to be executed on the CPU by reading data, output from the connection source function modules, from the memory.

The parallel execution device 102 is a computer device that executes a job by using the resource node 103 allocated by the resource brokering device 101 that manages the allocation status of the resource node 103 used for a service. The service is information processing that is offered to a computer terminal of the resource node 103. The service includes, for example, a non-interactive service, such as a payroll calculation process or a science and technology calculation process and an interactive service, such as an internet telephone or a video conference system. For example, the resource brokering device 101 obtains weight information of job net instantaneously executed for each of the services. The resource brokering device 101 dynamically changes the allocation of the resource node 103 for the services in accordance with the weight information.

The input module 601 includes a function to receive input of script data related to a job net in which job execution sequence is defined. Specifically, when a user manipulates the input device 520, such as the keyboard 521 and the mouse 522, shown in FIG. 5, the input module 601 receives input of script data related to a job net and holds the data in the memory.

The job net is constituted of at least one job and is a group of jobs for which job execution sequence and cooperation relationship are specified. The script data are data in which control script related to a job net is described and include execution data of jobs that constitute the job net.

At least one control script related to a job net may be described in script data. That is, the script data may describe control script related to one job net or may describe control script related to a plurality of job nets.

The allocating module 602 has a function to, when script data are input by the input module 601, allocate the resource node 103, which is allocated by the resource brokering device 101 in response to an allocation request of the resource node 103 that is used to execute a job net, to the job net.

Specifically, the allocating module 602 reads out script data from the memory and issues an allocation request of the resource node 103 to the resource brokering device 101 on the basis of execution data included in the script data. As a result, the allocating module 602 allocates the resource node 103, which is allocated by the resource brokering device 101, to the job net.

The allocation control module 603 has a function to control the allocating module 602 and allocate a resource node to each job net on the basis of script data input by the input module 601. Specifically, the allocation control module 603 reads out script data from the memory and determines whether a plurality of pieces of script data are input or control script related to a plurality of job nets is described in the script data, and then controls the allocating module 602 on the basis of the determination result.

For example, in the case where control script related to one job net is described in each piece of script data, every time each piece of script data is input, the allocation control module 603 controls the allocating module 602 and allocates the resource nodes 103 for each job net.

Further, in the case where control script related to a plurality of job nets is described in the script data, by separating the control script into pieces of control script regarding individual job nets, the allocation control module 603 controls the allocating module 602 and allocates the resource node 103 to each job net.

Here, the functions executed by the allocation control module 603 when the allocating module 602 is controlled to allocate the resource nodes 103 to each job net will be described. The generating/transmitting module 604 has a function to, when script data is input by the input module 601, transmit an allocation request of the resource node 103 used to execute each job net to the resource brokering device 101.

Specifically, the generating/transmitting module 604 reads out script data from the memory, generates an allocation request of the resource node 103 on the basis of execution data of jobs that constitute each job net, and transmits the allocation request to the resource brokering device 101.

The allocation request includes, for example, the number of resource nodes 103 requested, the priority of the resource node 103, and information related to a user account of a user that uses the parallel execution device 102. The allocation request transmitted to the resource brokering device 101 is, for example, stored in the allocation requests list table 200 shown in FIG. 2.

The resource brokering device 101, when receiving an allocation request from the parallel execution device 102, executes brokering of the resource node 103 for each job net on the basis of, for example, the contents stored in the allocation requests list table 200 and the resources list table 300.

Note that brokering process executed in the resource brokering device 101 is known, and a description of the brokering process is omitted. For example, brokering of the resource node 103 may be implemented by the above described existing art.

The receiving module 605 has a function to, after an allocation request has been transmitted by the generating/transmitting module 604, receive an allocation response of the resource (node 103 that may be used for execution of each job net from the resource brokering device 101. The allocation response includes, for example, node Ids, with which the resource nodes 103 allocated by the resource brokering device 101 are identified. The allocation response received by the receiving module 605 is, for example, stored as resource information in the allocated resources list table 400 shown in FIG. 4.

Then, the allocation control module 603 controls the allocating module 602 and allocates the resource node 103 to each job net on the basis of the allocation response received by the receiving module 605. Specifically, the allocation control module 603 controls the allocating module 602, reads out the corresponding resource information from the allocated resources list table 400, and allocates the resource node 103 to each job net on the basis of the resource information.

The detecting module 606 has a function to, after the resource node 103 has been allocated to the job net by the allocating module 602, detects whether a resource node used for that job net is insufficient. The result detected by the detecting module 606 is held in the memory.

Specifically, for example, the detecting module 606 may be configured to detect whether resource nodes used for a job net are insufficient, on the basis of execution status of jobs in a batch system to which the job net is set. The batch system is an information processing system that is able to execute a plurality of jobs that constitute a job net in accordance with control script.

In addition, even when resource nodes 103 are insufficient in an initial stage, there is a possibility that the allocated resource nodes 103 are taken away in order to use the resource nodes 103 in other services in a process of operating individual services. Even when this is the case, the detecting module 606 detects that resource nodes are insufficient.

The generating/transmitting module 604 has a function to, when the detecting module 606 has detected that resource nodes 103 are insufficient, transmit an allocation request of the resource node 103 used for a job net to the resource brokering device 101. Specifically, the generating/transmitting module 604 reads out the result, which is detected by the detecting module 606, from the memory and transmits an allocation request, to the resource brokering device 101, for adding resource nodes 103 in order to supplement insufficient resource nodes.

The sensing module 607 has a function to, after a resource node has been allocated to a job net by the allocating module 602, sense whether execution of the job net is completed. Specifically, the sensing module 607 monitors the job net being executed and senses whether execution of all jobs is completed in accordance with the control script. The result sensed by the sensing module 607 is held in the memory.

The generating/transmitting module 604 has a function to, when completion of execution is sensed by the sensing module 607, transmit a return notification of the resource nodes 103, which are allocated to the job net, to the resource brokering device 101. Specifically, the generating/transmitting module 604 reads out the result sensed by the sensing module 607 from the memory, generates a return notification of the resource nodes 103, which are allocated to the job net of which execution has been completed, and transmits the return notification to the resource brokering device 101. The return notification includes, for example, node Ids, with which resource nodes 103, allocated to the job net of which execution has been completed, are identified.

The stopping module 608 has a function to stop the usage of resource nodes 103, which are allocated to a job net by the allocating module 602. In addition, the receiving module 605 has a function to, after resource nodes 103 have been allocated to a job net by the allocating module 602, receive a release request of the resource nodes 103 from the resource brokering device 101. The release request includes node Ids, with which resource nodes 103, to which a release request is issued, are identified. The release request received by the receiving module 605 is held in the memory.

Specifically, the stopping module 608, when a release request has been received by the receiving module 605, reads out the release request from the memory and stops the usage of resource nodes 103 specified by that release request. That is, the stopping module 608 stops execution of a job net that uses resource nodes 103 specified by the release request.

The generating/transmitting module 604 has a function to, when the usage of resource nodes 103 has been stopped by the stopping module 608, transmit a return notification of the resource nodes 103 to the resource brokering device 101. As a result, the resource nodes 103 allocated for execution of a job net are returned to the resource brokering device 101.

In addition, the allocation control module 603 may be configured to allocate resource nodes 103 for each batch system in such a manner that the allocating module 602 is controlled to activate batch systems in which corresponding job nets are set in units of the job net. In this case, the generating/transmitting module 604 transmits an allocation request of resource nodes 103 used for a batch system on the basis of execution data of jobs that are set in the batch system to the resource brokering device 101.

Then, the receiving module 605, after the allocation request has been transmitted by the generating/transmitting module 604, receives an allocation response of resource nodes 103 that may be used for the batch system from the resource brokering device 101. The allocation control module 603 controls the allocating module 602 and allocates the resource nodes 103 on the basis of the allocation response received by the receiving module 605.

The detecting module 606 may be configured so that, after resource nodes 103 have been allocated to a batch system by the allocating module 602, the detecting module 606 detects whether the resource nodes 103 used in the batch system are insufficient, and, when it is detected that the resource nodes 103 are insufficient, the generating/transmitting module 604 transmits an allocation request of the resource nodes 103 used for the batch system to the resource brokering device 101.

The sensing module 607 may be configured so that, after resource nodes 103 have been allocated to a batch system by the allocating module 602, the sensing module 607 senses whether execution of a job net that is set in the batch system is completed, and, when completion of execution is sensed, the generating/transmitting module 604 transmits a return notification of the resource nodes 103, which are allocated to the batch system, to the resource brokering device 101.

Moreover, the stopping module 608 may be configured to stop a batch system when completion of execution is sensed by the sensing module 607. In addition, when a release request of the resource nodes 103 used in a batch system is received by the receiving module 605, the stopping module 608 may be configured to stop the batch system and the generating/transmitting module 604 may be configured to transmit a return notification of the resource nodes 103 allocated to the batch system to the resource brokering device 101.

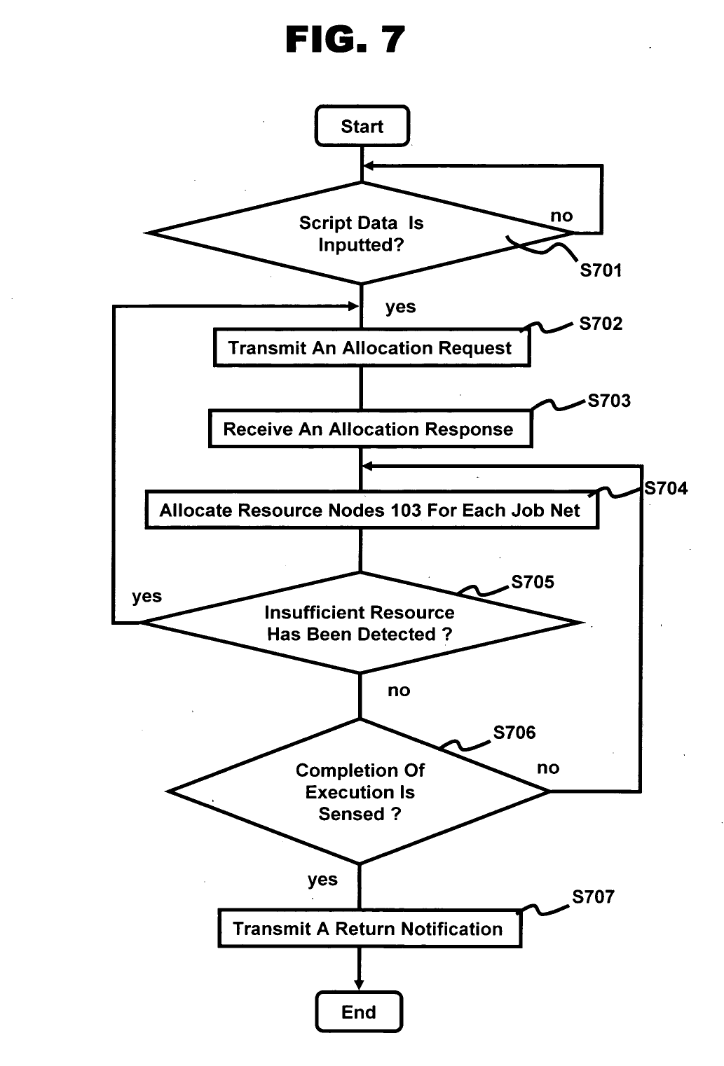

Parallel Execution Procedure of Parallel Execution Device 102 Next, the parallel execution procedure of the parallel execution device 102 will be described. FIG. 7 is a flowchart that shows the parallel execution procedure of the parallel execution device 102 according to the embodiment. In the flowchart shown in FIG. 7, first, the input module 601 determines whether input of script data regarding a job net in which job execution sequence is defined is received (step S701).

Here, when input of script data is awaited (step S701: No) and then script date is input (step S701: Yes), the generating/transmitting module 604 transmits an allocation request of resource nodes 103 used for execution of each job net to the resource brokering device 101 (step S702).

After that, the receiving module 605, after the allocation request has been transmitted by the generating/transmitting module 604, receives an allocation response of resource nodes 103 that may be used for execution of each job net from the resource brokering device 101 (step S703). Then, the allocation control module 603 controls the allocating module 602 and allocates resource nodes 103 for each job net on the basis of the allocation response received by the receiving module 605 (step S704).

Then, the detecting module 606, after the resource nodes 103 have been allocated to the job nets by the allocating module 602, determines whether resource nodes 103 used for the corresponding job nets are insufficient (step S705). Here, when insufficient resource has been detected (step S705: Yes), the process proceeds to step S702 and an additional allocation request to supplement insufficient resource is transmitted.

On the other hand, when insufficient resource is not detected (step S705: No), the sensing module 607 senses whether execution of the job nets is completed (step S706). Here, when completion of execution is sensed (step S706: Yes), the generating/transmitting module 604 transmits a return notification of the resource nodes 103 allocated to the job nets to the resource brokering device 101 (step S707), and then a series of processes through the flowchart ends. In addition, when completion of execution is not sensed in step S706 (step S706: No), the process proceeds to step S705.

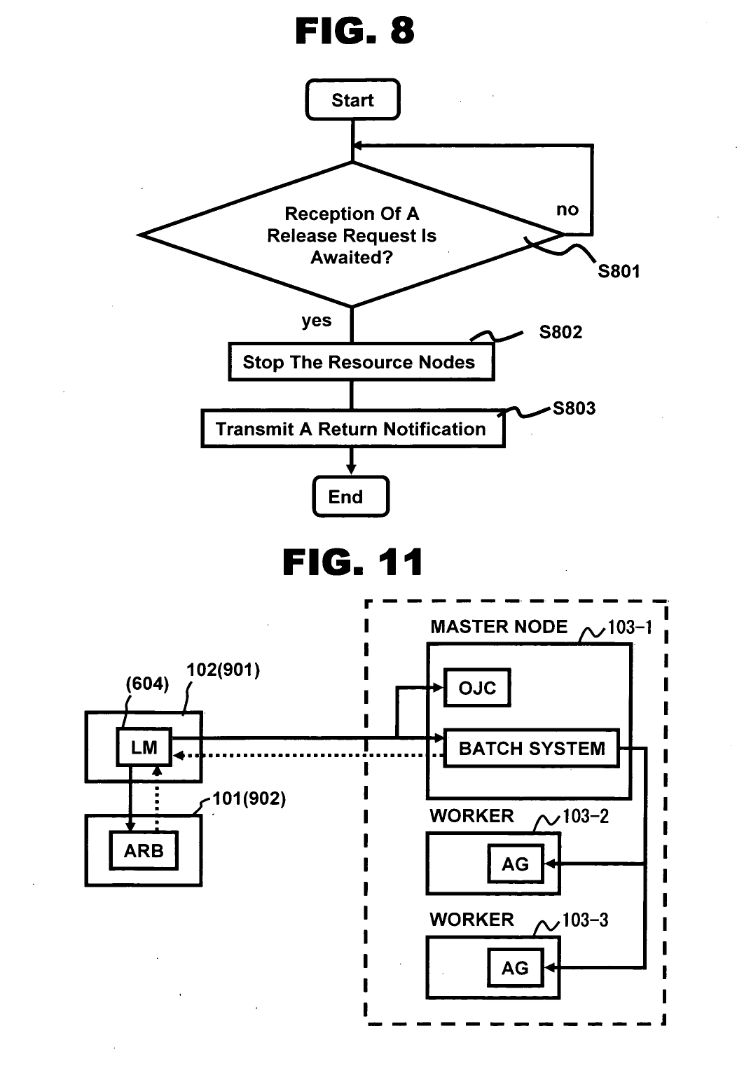

Next, the resource return procedure that is executed in the parallel execution device 102 when a release request of resource nodes 103 is issued from the resource brokering device 101 will be described. FIG. 8 is a flowchart that shows the resource return procedure. As shown in FIG. 8, after resource nodes 103 have been allocated to job nets by the allocating module 602, the receiving module 605 determines whether a release request of the resource nodes 103 is received from the resource brokering device 101 (step S801).

Here, when reception of a release request is awaited (step S801: No) and then a release request is received (step S801: Yes), the stopping module 608 stops the resource nodes 103 specified by the release request (step S802). Finally, the generating/transmitting module 604, when the usage of resource nodes 103 has been stopped by the stopping module 608, transmits a return notification of the resource nodes 103 to the resource brokering device 101 (step S803), and then a series of processes through the flowchart ends.

Thus, according to the present embodiment, when a plurality of job nets are executed parallel, an allocation request may be issued for each job net and, hence, the resource nodes 103 allocated from the resource brokering device 101 may be allocated to each job net.

Moreover, when resource becomes insufficient during execution of job nets that use resource nodes 103 allocated to each job net, it is possible to issue an allocation request of resource nodes 103 that are additionally allocated to the job net.

In addition, when execution of a job net is completed, the resource nodes 103 allocated to the job net may be returned to the resource brokering device 101. Further, when a release request of resource nodes 103 has been issued, it is possible to interrupt or abort the job net that uses those resource nodes 103 and return the resource nodes 103 to the resource brokering device 101.

In this manner, by issuing an allocation request of resource nodes 103 for each job net and allocating the resource nodes 103 in accordance with the allocation request, it is possible to effectively execute resource brokering and to smoothly offer individual services.

### First Exemplary Embodiment

A first exemplary embodiment of the resource brokering system 100 will now be described. First, the detailed system configuration of the resource brokering system 100 will be described. FIG. 9 is a detailed system configuration diagram of the resource brokering system 100. The resource brokering system 100 is constituted of grid service subsystems 901, a resource brokering subsystem 902, a grid information subsystem 903, and an operation management subsystem 904.

The grid service subsystem 901 is a subsystem that implements individual services executed in a grid, and one grid service subsystem 901 is prepared each type of service. The grid is a technology in which a plurality of geographically dispersed computer systems are connected through a network to give a virtual one system that provides computing power. The grid service subsystem 901 allows an existing application to be compatible with a grid environment and to be executed as a service on the resource brokering system 100.

In addition, the resource brokering subsystem 902 receives a resource request from the grid service subsystems 901 and brokers a physically required resource nodes 103 to execute services. The resource brokering subsystem 902 adjusts distribution of resource allocation to each service so as to satisfy a resource request for a service having a higher priority level. Further, the resource brokering subsystem 902 also provides a function to accommodate resource requests on the basis of priority levels of the services and resources, and provides a function to switch applications to be executed for individual resource nodes 103.

In addition, the grid information subsystem 903 is a subsystem that collects and offers various pieces of information stored in the resource brokering device 101. For example, the grid information subsystem 903 collects and offers information regarding the individual resource nodes 103 (CPU performance, and type of OS) and/or information regarding services (load, and acquisition status of resource nodes 103).

In addition, the operation management subsystem 904 is a subsystem that is used for operating management of the resource brokering device 101. The operation management subsystem 904 confirms the entire operational status of the resource brokering device 101 and also sets the operational policy of the resource brokering device 101.

Next, modules that constitute the resource brokering system 100 will be described. In FIG. 9, life cycle managers LM are modules of the grid service subsystem 901. Each of the life cycle managers LM manages the corresponding resource node 103, which is allocated to a service, from the start of the service to the end of the service. In addition, the life cycle manager LM requests an arbitrator ARB to add or release the resource node 103 in accordance with variation in load on the service. Moreover, the life cycle manager LM provides a function to autonomously adjust the priority levels of the managing resource nodes 103.

In addition, a life cycle manager factory service LMFS is a module of the resource brokering subsystem 902. The life cycle manager factory service LMFS activates and stops services. The life cycle manager factory service LMFS, when receiving a request for activating a service, requests resource nodes 103 for executing the life cycle manager LM of that service and activates the life cycle manager LM using the allocated resource nodes 103. Moreover, the life cycle manager factory service LMFS, when receiving a request for stopping a service, stops the life cycle manager LM of that service and releases the resource nodes 103.

In addition, the arbitrator ARB is a module of the resource brokering subsystem 902. The arbitrator ARB receives a request to add or release resource nodes 103 from the life cycle manager LM and then allocates the resource nodes 103 to each service. Moreover, the arbitrator ARB performs accommodation on the basis of the priority levels of services and concentrates the computational power of the grid on the services having higher priority levels.

In addition, a physical resource broker PRB is a module of the resource brokering subsystem 902. The physical resource broker PRB brokers the resource nodes 103, which have capabilities and/or functions to execute a service, to the arbitrator ARB on the basis of a physical attribute information of each resource node 103 within the grid.

In addition, a resource role switcher RRS is a module of the resource brokering subsystem 902. The resource role switcher RRS executes switching of services (applications) executed by the resource nodes 103.

In addition, node monitors NM are modules for the grid information subsystem 903. The node monitor NM is arranged one by one in each resource node 103, collects information (type and load of CPU, memory utilization, and the like) of the resource node 103, and regularly reports the information to a cluster manager CM. Moreover, an adaptive services control center ASCC physically performs a service switching process on resource nodes 103 in accordance with a logical switching process executed in the resource brokering subsystem 902.

In addition, the cluster manager CM is a module for the grid information subsystem 903, and is arranged one by one in each site C. The cluster manager CM relays information collected from the node monitors NM in the site C to a root server RS.

In addition, the root server RS is a module of the grid information subsystem 903 and aggregates all pieces of information of the resource nodes 103 within the grid.

Moreover, an archiver AR is a module of the grid information subsystem 903. The archiver AR is a module that stores information aggregated in the root server RS to compile a database. The archiver AR offers search function of the database to the resource brokering subsystem 902.

In addition, an agent AG receives an application executed by the corresponding resource node 103 and connects the application to the life cycle manager LM. Moreover, an application wrapper AW is a module for the resource brokering subsystem 902 and is arranged in each resource node 103 of grid. The application wrapper AW wraps API of an application executed by the corresponding resource node 103.

In addition, an administration portal APTL is a module of the resource brokering subsystem 902 and offers an interface with which an administrator of a service executed in the grid activates or stops the service.

In addition, an administration console ACNS is a module of the operation management subsystem 904 and offers an interface with which an administrator of the resource brokering device 101 sets and adjusts the entire resource brokering system 100.

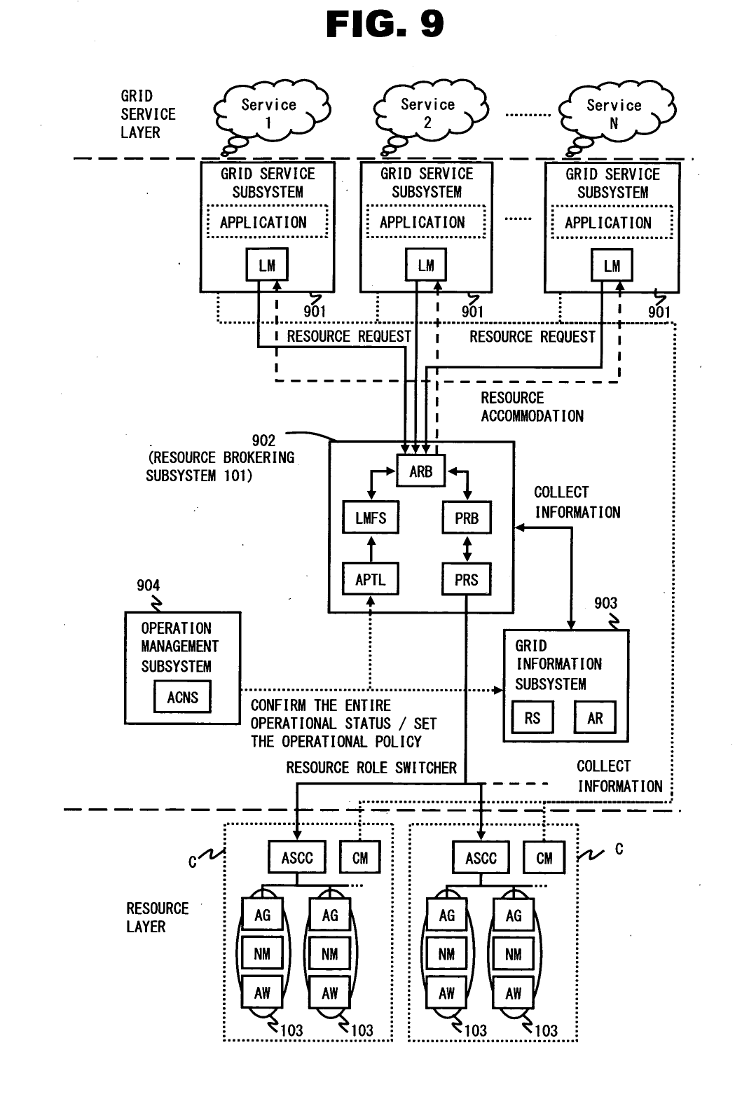

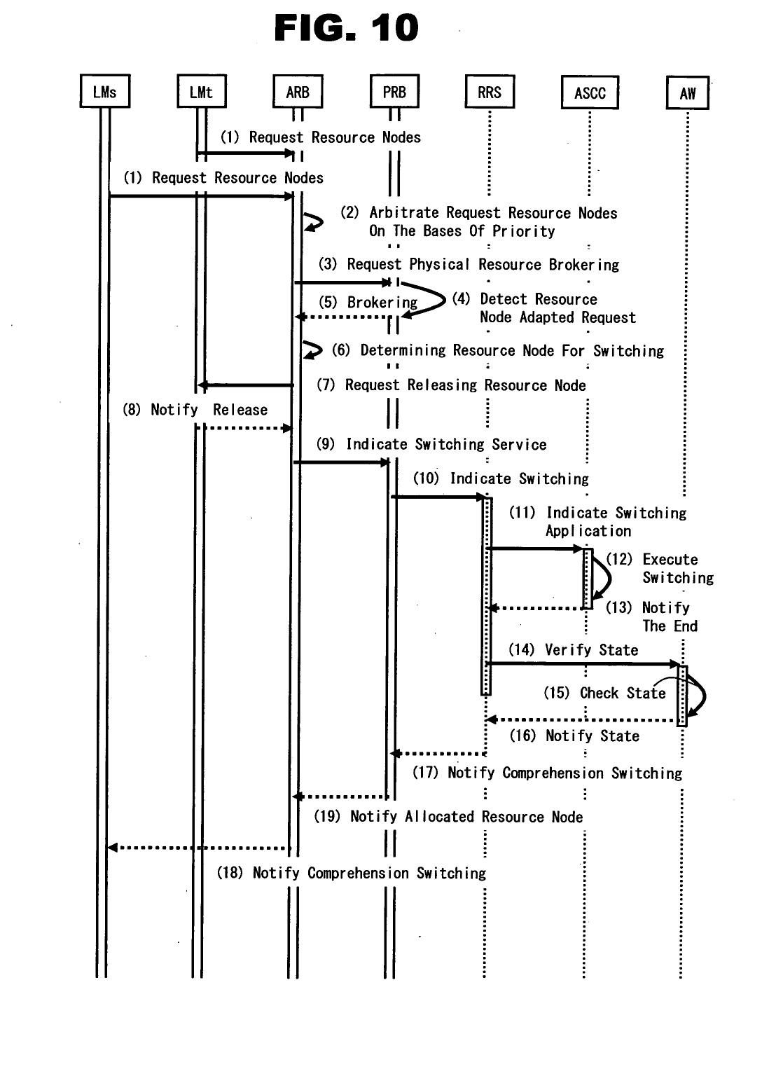

Next, a resource brokering process executed in the first exemplary embodiment will be described. FIG. 10 is a sequence diagram that shows the resource brokering process according to the first exemplary embodiment. The example shown in FIG. 10 is a typical operation sequence relating to a request and allocation of resource nodes 103. In this example, it is given that the priority level of a service s is higher than the priority level of a service t. Note that parenthetical numbers represent the order of sequence.

The arbitrator ARB handles the request of the life cycle manager LM (hereinafter, denoted by “LMs”) of the service s prior to the request of the life cycle manager LM (hereinafter, denoted by “LMt”) of the service t in order to accommodate a resource node request from the life cycle manager LM on the basis of the priority level of the service.

In FIG. 10, as a result of accommodation in the arbitrator ARB, it is determined to switch the resource node 103 from allocation to the service s over to allocation to the service t, and a sequence that performs switching by cooperation among the modules, that is, the physical resource broker PRB, the resource role switcher RRS, the adaptive services control center ASCC, the application wrapper AW, is shown.

Next, a parallel execution process executed in the first exemplary embodiment will be described. FIG. 11 is a diagram that illustrates a specific system configuration of the resource brokering system 100 according to the first exemplary embodiment. In the first exemplary embodiment, the function of the allocating module 602 of the parallel execution device 102 shown in FIG. 6 is implemented by using a plurality of computers (the parallel execution device 102 and the resource nodes 103).

Specifically, when it is difficult to activate a plurality of batch systems on the parallel execution device 102, some of the batch systems are activated on the resource nodes 103 and job nets are set to those batch systems. The number of batch systems to be activated on the resource nodes 103 dynamically varies in accordance with the number of job nets.

For example, when the number of job nets to be executed is three, batch systems are respectively activated on three resource nodes 103. Here, an example when the number of job nets to be executed is one will be described. Note that, when multiple number of job nets need to be executed, the parallel execution process described below will be executed for each job net.

In FIG. 11, it is given that the resource nodes 103-1 to 103-3 each have a function with which the parallel execution device 102 is provided. Specifically, a parallel execution program that implements the function of the parallel execution device 102 is installed in each of the resource nodes 103-1 to 103-3. Further, the parallel execution device 102 provides a function to enable remote execution on the resource nodes 103.

Specifically, by using a control portion (hereinafter, referred to as “organic job controller OJC”) that controls a job execution sequence on the basis of script data, the parallel execution device 102 enables remote execution on the resource nodes 103. Furthermore, the parallel execution device 102 also enables remote execution on the resource nodes 103 on the basis of various requests to a batch system and various responses from a batch system.

In addition, the arbitrator ARB determines an allocation policy of the resource nodes 103 on the basis of a user account of the parallel execution device 102. Here, it is given that, in response to a resource request transmitted from the life cycle manager LM of the parallel execution device 102, the arbitrator ARB allocates at least one resource node 103 and, further, allocates the resource node 103 in accordance with a policy set by an administrator of the resource brokering system 100. Note that the life cycle manager LM corresponds to the generating/transmitting module 604 shown in FIG. 6.

In FIG. 11, a batch system is activated on the resource node 103-1 (hereinafter, the resource node 103 that executes the batch system is referred to as “master node”). Moreover, the resource nodes 103-2, 103-3 are allocated to the parallel execution device 102 by the arbitrator ARB (hereinafter, the resource node 103 allocated to the parallel execution device 102 is referred to as “worker”).

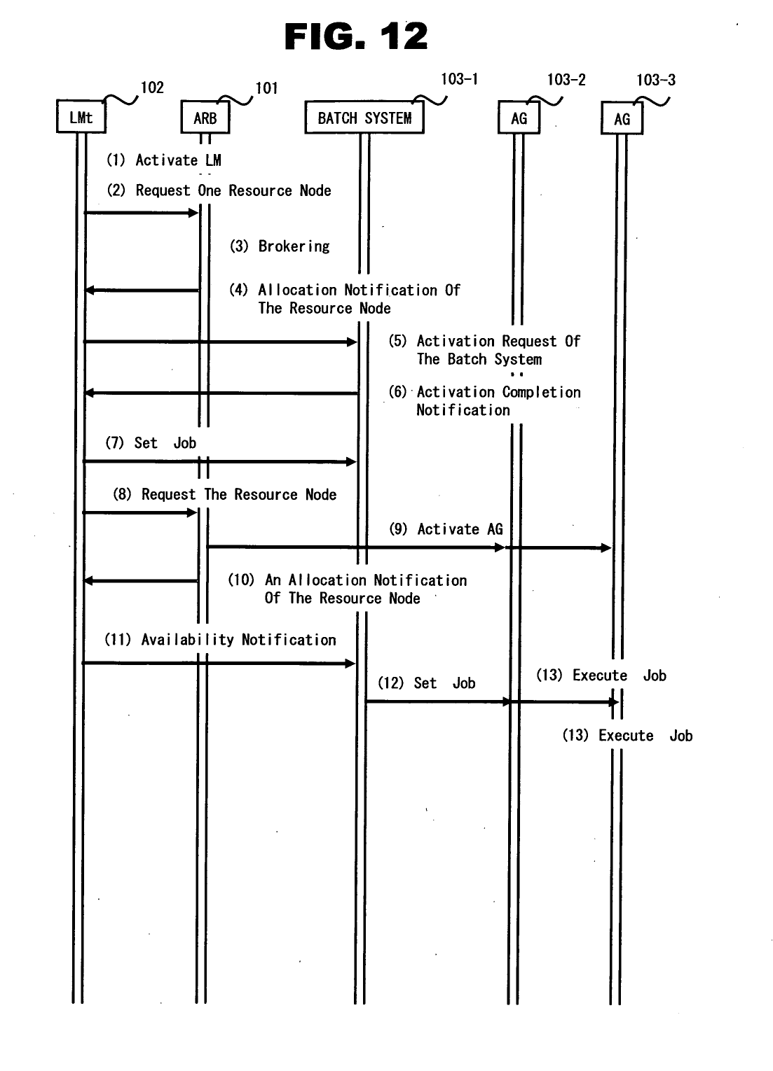

Here, the parallel execution procedure according to the first exemplary embodiment will be described. FIG. 12 is a sequence diagram (part I) that shows the parallel execution process according to the first exemplary embodiment. The example shown in FIG. 12 is a typical operation sequence executed in each job net. Note that parenthetical numbers represent the order of sequence.

First, when script data regarding a job net are input to the parallel execution device 102, the life cycle manager LM is activated (step 1). Next, the life cycle manager LM requests one resource node 103 for activating a batch system to the arbitrator ARB (step 2).

After that, the arbitrator ARB brokers on the basis of a resource node request from the life cycle manager LM (step 3), and issues an allocation notification of the resource node 103 to the life cycle manager LM (step 4). The life cycle manager LM performs an activation request of the batch system to the resource node 103-1 (hereinafter, referred to as “master node 103-1”) in accordance with the allocation notification from the arbitrator ARB (step 5).

The master node 103-1 activates the batch system and issues an activation completion notification to the life cycle manager LM (step 6). Subsequently, the life cycle manager LM controls the organic job controller OJC and sets a job (job net) to the batch system of the master node 103-1 (step 7).

Thereafter, the life cycle manager LM monitors the number of jobs in the batch system and requests the arbitrator ARB of the resource node 103 in accordance with the number of jobs queued in the batch system of the master node 103-1 (step 8).

The arbitrator ARB determines the resource nodes 103-2, 103-3 to be allocated by brokering in accordance with a resource node request from the life cycle manager LM, activates agents AG of the resource nodes 103-2, 103-3 (step 9), and issues an allocation notification of these resource nodes 103-2, 103-3 (10).

After that, the life cycle manager LM issues an availability notification (for example, any one of the pieces of resource information 400-1 to 400-n in the allocated resources list table 400 shown in FIG. 4) of the allocated resource nodes 103-2, 103-3 (hereinafter, referred to as “workers 103-2, 103-3”) to the batch system of the master node 103-1 (11).

The batch system of the master node 103-1 sets a job to the agents AG of the workers 103-2, 103-3 specified by the availability notification from the life cycle manager LM on the basis of control script of the job net (12) and executes a job using the workers 103-2, 103-3 (13).

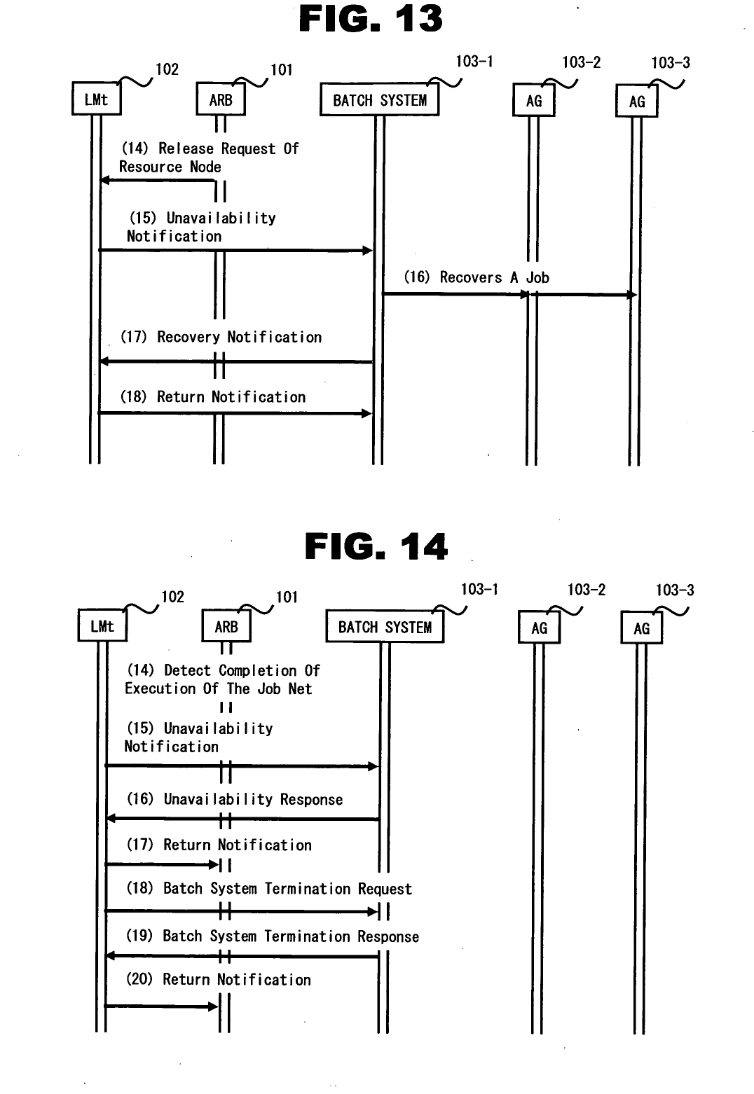

Next, an execution termination sequence of the parallel execution process according to the first exemplary embodiment will be described. The execution termination sequence will be initiated when a resource release request is notified from the arbitrator ARB or when execution of a job net is completed. FIG. 13 and FIG. 14 are sequence diagrams (part III and part IV) that show the parallel execution process according to the first exemplary embodiment.

In FIG. 13, when a release request of the resource node 103 is notified from the arbitrator ARB (14), the life cycle manager LM issues an unavailability notification of the workers 103-2, 103-3 to the batch system of the master node 103-1 (15).

Next, the batch system of the master node 103-1 recovers a job from the workers 103-2, 103-3 (returns a job to the head of a queue) (16) and issues a recovery notification to the life cycle manager LM (17).

After that, the life cycle manager LM issues a return notification of the workers 103-2, 103-3 to the arbitrator ARB (18) and, as a result, the workers 103-2, 103-3 are returned to the arbitrator ARB. Thereafter, the batch system of the master node 103-1 awaits an availability notification from the life cycle manager LM and, when the availability notification is issued, sets a job in accordance with that notification and then re-executes the job.

In FIG. 14, when completion of execution by the organic job controller OJC is detected, that is, completion of execution of the job net (work flow) is detected (14), the life cycle manager LM issues an unavailability notification of the workers 103-2, 103-3 to the batch system of the master node 103-1 (15).

After that, when an unavailability response is issued from the batch system of the master node 103-1 (16), the life cycle manager LM issues a return notification of the workers 103-2, 103-3 to the arbitrator ARB (17) and, as a result, the workers 103-2, 103-3 are returned to the arbitrator ARB.

Then, the life cycle manager LM issues a batch system termination request to the batch system of the master node 103-1 (18). After that, when a batch system termination response is issued from the master node 103-1 (19), the life cycle manager LM issues a return notification of the master node 103-1 to the arbitrator ARB (20) and, as a result, the master node 103-1 is returned to the arbitrator ARB.

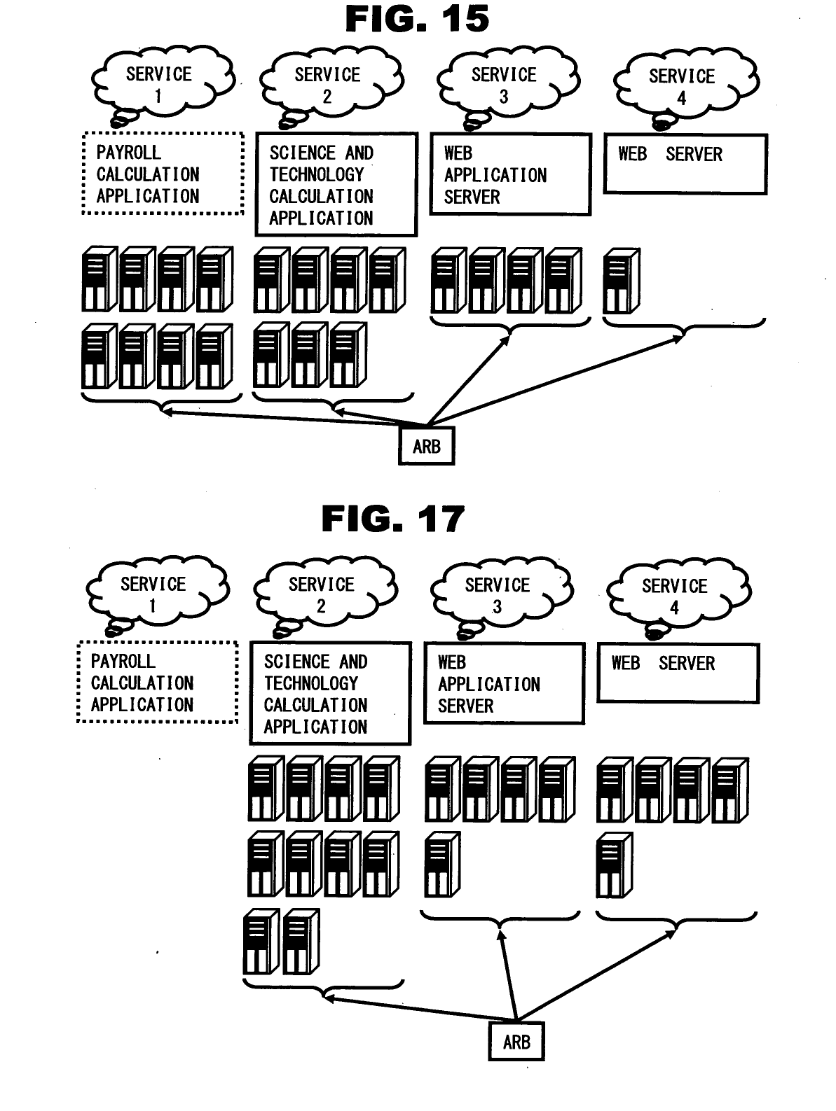

Here, an example of execution of the resource brokering system 100 will be described. FIG. 15 to FIG. 17 are diagrams that illustrate examples of execution of the resource brokering system 100. Here, the case when a payroll calculation application and a science and technology calculation application are offered as a non-interactive service, and a Web application server and a Web server are offered as an interactive service will be described.

The payroll calculation application and the science and technology calculation application are executed by inputting execution data and control script regarding a job net that executes applications to the parallel execution device 102. In addition, it is given that a policy shown below is set by an administrator of the resource brokering system 100. Note that the number of allocatable resource nodes 103 is 20.

(a) At least one resource node 103 is allocated to the Web server and, further, resource nodes 103 are allocated as many as possible in response to a demand from the Web server. (b) At least two resource nodes 103 are allocated to the payroll calculation application and, further, an equally-divided number of the remaining resource nodes 103 are allocated to the payroll calculation application.

(c) Equally-divided numbers of the resource nodes 103 are allocated to the Web application server. (d) Twice an equally-divided number of the remaining resource nodes 103 are allocated to the science and technology calculation application. Note that the equally-divided numbers of the remaining resource nodes 103 are obtained by, after a minimum necessary number of resource nodes 103 are allocated to each service, dividing the remaining resource nodes 103 by the number of services.

In FIG. 15, when the resource nodes 103 are allocated to each service in accordance with the policy, the payroll calculation application has allocated eight resource nodes 103, the science and technology calculation application has allocated seven resource nodes 103, the Web application server has allocated four resource nodes 103, and the Web server has allocated one resource node 103. As a result, in accordance with the control script, the payroll calculation application and the science and technology calculation application will be executed.

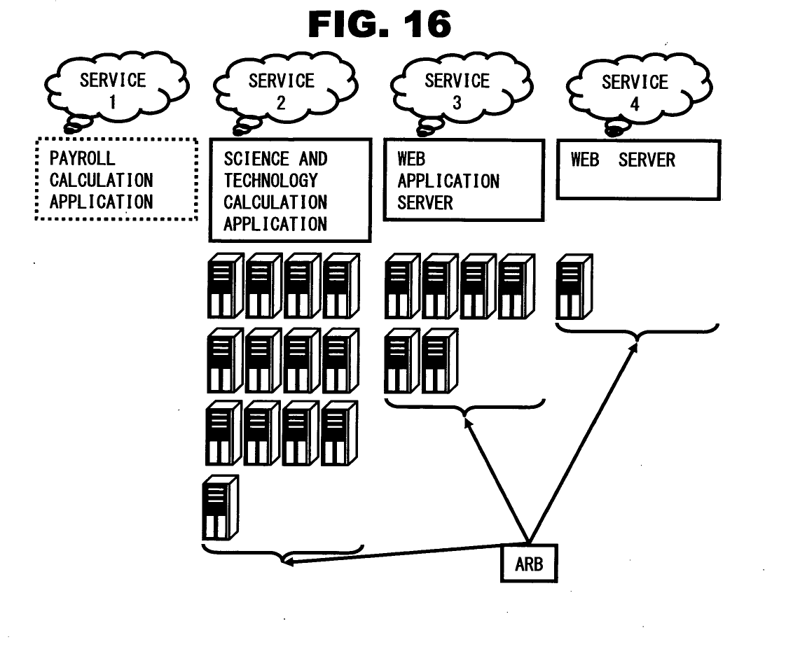

In FIG. 16, when the payroll calculation application ends, the number of the remaining resource nodes 103 becomes 19 and, as a result, the science and technology calculation application has allocated 13 (12.6) resource nodes 103, the Web application server has allocated six (6.3) resource nodes 103, and the Web server has allocated one resource node 103.

In FIG. 17, when the demand from the Web server is increased, in accordance with the level of importance of each service, the science and technology calculation application has allocated ten resource nodes 103, the Web application server has allocated five resource nodes 103, and the Web server has allocated five resource nodes 103.

According to the first exemplary embodiment, it is possible to reduce total cost. Specifically, it is possible to integrate servers that are established as separate systems into one system, or it is possible to integrate geometrically dispersed servers into one system, or it is possible to improve the peak performance of each service by interchanging spare resource nodes 103 among a plurality of services.

Particularly, it is possible to easily shift an existing application into a grid environment by only describing a job net regarding a non-interactive service. Thus, for example, it is possible to realize overall optimization of resource brokering both an online system (Web application, Web server) and a batch system (payroll calculation application, science and technology calculation application) in cooperation.

In addition, it is possible to implement a system that flexibly copes with variation in circumstances of business. Specifically, it is possible to automatically provide a service with computational power in accordance with a required amount, it is possible to automatically concentrate computational power on a service having a higher priority level, and it is possible to autonomously adjust the priority level of a service in response to a change in circumstances.

Note that it is applicable that a cash area used for a read-only file is prepared in each resource node 103 and a file name is specified in the script of the organic job controller OJC. Specifically, as a job is set by the organic job controller OJC, an instruction to transfer a read-only file is issued to a batch system.

The batch system transfers a file to the cash area when the file has not been transferred to the resource node 103 that is used for execution of a job. Thus, because it is possible to reduce retransfer of a common read-only file, it is possible to improve the efficiency of process during execution of job net.

### Second Exemplary Embodiment

A second exemplary embodiment of the resource brokering system 100 will now be described. Note that the same modules described in the first exemplary embodiment are not shown and a description thereof is omitted. In the second exemplary embodiment, the function of the allocating module 602 (see FIG. 6) is implemented by using a virtual machine that is booted inside the parallel execution device 102.

Specifically, the parallel execution device 102 has a virtual image of a VM (Virtual Machine) that implements a process executed by the master node 103-1, which is described in the first exemplary embodiment. In addition, the parallel execution device 102 uses the organic job controller OJC to enable remote execution on a machine established on the virtual image, and shares a data file that runs on the machine and on the VM.

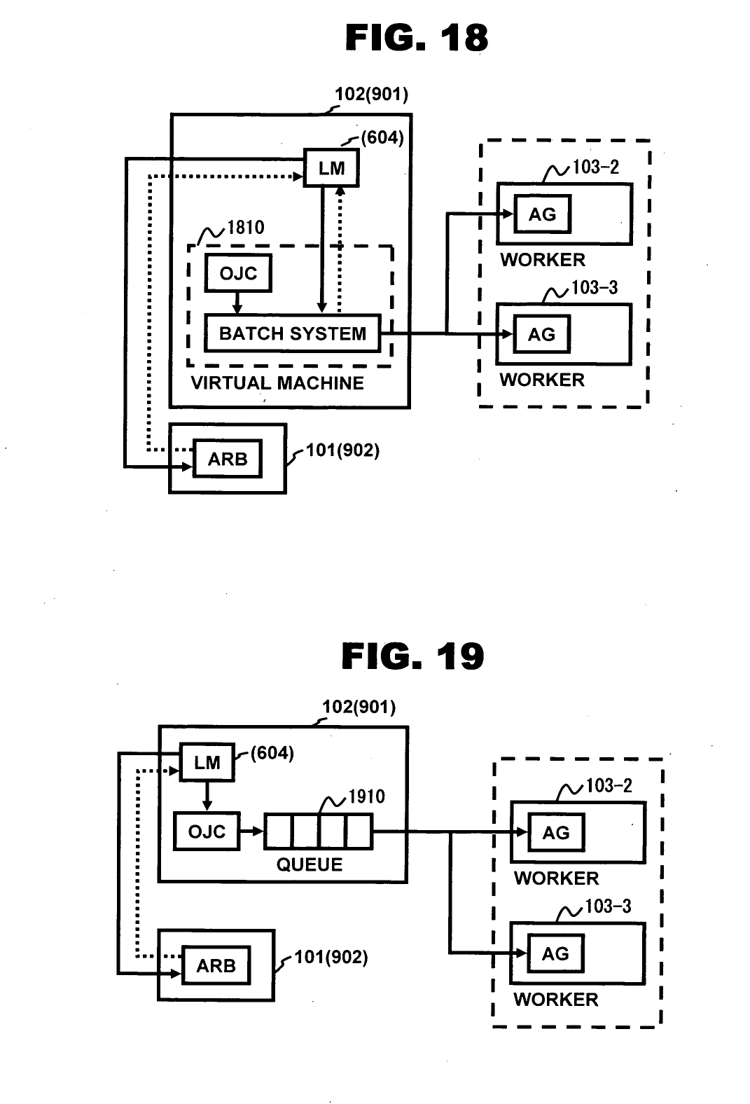

FIG. 18 is a diagram that illustrates a specific system configuration of the resource brokering system 100 according to the second exemplary embodiment. In FIG. 18, the parallel execution device 102 establishes a virtual machine 1810 inside and activates a batch system on the virtual machine 1810. In addition, the workers 103-2, 103-3 are allocated to the parallel execution device 102 by the arbitrator ARB.

The number of life cycle managers LM and the number of virtual machines, which are booted in the parallel execution device 102, are dynamically varied in response to the number of job nets. Here, an example when the number of job nets to be executed is one will be described. Note that, when a plurality of job nets to be executed are present, a plurality of the life cycle managers LM and a plurality of the virtual machines are booted.

Here, only the modules of an operational sequence of the parallel execution process executed in the second exemplary embodiment, which are different from those of the operational sequence of the parallel execution process in the first exemplary embodiment, will be described. Instead of processes executed in (step 2) to (step 4) shown in FIG. 12, the virtual machine 1810 is booted from the virtual image of a VM and a batch system is then activated on the virtual machine 1810.

At this time, an unused machine among virtual machines that are prepared in advance for use in a parallel execution process may be selectively booted or a new virtual machine may be booted from the copy of a boot image. Even in any cases, the machine ID (host name, IP address, and the like) of the booted virtual machine 1810 is held in the memory.

After that, the life cycle manager LM controls the organic job controller OJC to set a job (job net) to the batch system on the virtual machine 1810.

In addition, instead of the processes executed in (15) to (19) shown in FIG. 14, the life cycle manager LM, when detecting completion of a job net, issues an unavailability notification of the workers 103-2, 103-3 to the batch system on the virtual machine 1810.

Then, when an unavailability response is issued from the batch system on the virtual machine 1810, the life cycle manager LM issues a return notification of the workers 103-2, 103-3 to the arbitrator ARB and, as a result, the workers 103-2, 103-3 are returned to the arbitrator ARB. Finally, the VM is shut down or suspended for waiting.

According to the second exemplary embodiment, because the functions of the parallel execution device 102 need not be provided in the resource nodes 103-1 to 103-3, it is possible to reduce operational costs of the resource brokering system 100. Furthermore, because the parallel execution process may be executed by one machine (parallel execution device 102), it is possible to improve the efficiency.

### Third Exemplary Embodiment

A third exemplary embodiment of the resource brokering system 100 will now be described. Note that the same modules described in the first exemplary embodiment are not shown and a description thereof is omitted. In the third exemplary embodiment, the functions of the allocating module 602 (see FIG. 6) of the parallel execution device 102 is implemented by dynamically creating a queue for perform queue control on a job net instead of booting a batch system.

FIG. 19 is a diagram that illustrates a specific system configuration of the resource brokering system 100 according to a third exemplary embodiment. The number of queues created is dynamically varied in accordance with the number of job nets. Here, an example when the number of job nets to be executed is one will be described. Note that, when a plurality of job nets to be executed are present, a plurality of queues are created.

In FIG. 19, the parallel execution device 102 has already activated the life cycle manager LM. In addition, the parallel execution device 102 secures a memory area for performing queue control on the job net, and a queue 1910 is created. In addition, the workers 103-2, 103-3 are allocated to the parallel execution device 102 by the arbitrator ARB.

Here, only the modules of an operational sequence of the parallel execution process executed in the third exemplary embodiment, which are different from those of the operational sequence of the parallel execution process in the first exemplary embodiment, will be described. Instead of processes executed in (step 2) to (step 7) shown in FIG. 12, a new queue is created on the batch system. A queue name created at this time uses a presently nonexistent name.

After that, the life cycle manager LM controls the organic job controller OJC to set a job (job net) to the batch system. At this time, a job is set by specifying a newly created queue.

Moreover, instead of the processes executed in (15) to (19) shown in FIG. 14, a newly created queue is eliminated.

According to the third exemplary embodiment, because the functions of the parallel execution device 102 need not be provided in the resource nodes 103-1 to 103-3, it is possible to reduce operational costs of the resource brokering system 100.

As described above, According to the parallel execution program, the recording medium that stores the program, the parallel execution device and the parallel execution method, individual services may be smoothly offered by effectively executing resource brokering for each job net.

Note that the parallel execution method described in the present embodiment may be implemented by executing a program, which is prepared in advance, on a computer, such as a personal computer or a workstation. The program is recorded in a computer readable recording medium, such as a hard disk, a flexible disk, a CD-ROM, an MO, a DVD, and is executed in such a manner that the computer reads the program from the recording medium. Furthermore, the program may be a transmission medium that is distributable through a network, such as Internet.

Further, the above described parallel execution device 102 may be implemented by an intended purpose IC (hereinafter, simply referred to as “ASIC”), such as a standard cell and a structured ASIC (Application Specific Integrated Circuit), or a PLD (Programmable Logic Device), such as an FPGA. Specifically, for example, the functional configurations 601 to 608 of the above described parallel execution device 102 are functionally defined using HDL description, and that HDL description is logically synthesized and then given to the ASIC or the PLD. Thus, it is possible to manufacture the parallel execution device 102.

As described above, a parallel execution program, a recording medium that stores the program, a parallel execution device and a parallel execution method, according to the present embodiment, is useful for a system that determines a resource node used for a service.

What is claimed is:

1. A method for controlling a plurality of nodes for executing a plurality of services, each of the services comprising a plurality of job nets which are to be executed sequentially, the method comprising:
allocating at least one node for each of said services and initiating execution of said services by said nodes;
obtaining weight information of job nets instantaneously executed for each of the services; and
dynamically changing the allocation of the nodes for the services in accordance with the weight information.

2. The method according to claim 1, wherein said service comprises at least one script information, and said script information comprises at least one said job net.

3. The method according to claim 1, further comprising,
obtaining weight information of the script information instantaneously executed for each of the services,
wherein the changing step changes the allocation of the nodes for the services in accordance with the weight information for said script information.

4. The method according to claim 1, wherein the changing step changes the allocation when said nodes executing job net are insufficient.

5. The method according to claim 1, wherein the changing step changes the allocation when said node completes execution of said job net.

6. A parallel execution apparatus in a system comprising a plurality of nodes for executing a plurality of services, each of the services comprising a plurality of job nets which are to be executed sequentially, and a resource brokering device for allocating of said node for each of said services, the apparatus comprising:
an allocating module for allocating at least one node for each of said services and initiating execution of said services by said nodes;
an obtaining module for obtaining script information comprising at least one job net of execution;
a generating module for generating information comprising allocation of said node executing said job nets;
a transferring module for transferring said request information to said resource brokering device for obtaining weight information of job nets instantaneously executed for each of the services and for changing dynamically the allocation of the nodes for the services in accordance with the weight information;
a requesting module for requesting execution of said job nets to said node determined by said resource brokering device; and
an allocating module for allocating said node for each job nets.

7. The parallel execution apparatus according to claim 6, further comprising, a detecting module for detecting whether said nodes executing job nets are insufficient,
wherein said transferring module transfers said request information to said resource brokering device,

8. The parallel execution apparatus according to claim 6, further comprising, a detecting module for detecting whether said node completes execution of said job nets,
wherein said transferring module transfers said return information of said node to said resource brokering device,

9. The parallel execution apparatus according to claim 5, wherein said transferring module transfers information for stopping execution of job net to said node when release request of said node receives from said resource brokering device,

10. A system comprising:
a plurality of nodes for executing service for executing a plurality of services, each of the services comprising a plurality of job nets which are to be executed sequentially;
an allocating module for allocating at least one node for each of said services and initiating execution of said services by said nodes;
an obtaining module for obtaining script information comprising at least one job net of execution;
a generating module for generating information comprising allocation of said node executing said job nets;
a transferring module for transferring said request information to said resource brokering device for obtaining weight information of job nets instantaneously executed for each of the services and for changing dynamically the allocation of the nodes for the services in accordance with the weight information;
a requesting module for requesting execution of said job nets to said node determined by said resource brokering device; and
an allocating module for allocating said node for each job nets.
